(19) United States
(12) Patent Application Publication
(10) Pub. No.: US 2018/0064029 A1
(43) Pub. Date: Mar. 8, 2018

(54) CUTTING BLADES FOR ROTARY CUTTER

(71) Applicant: Diane Panasiuk, Tecumseh (CA)

(72) Inventor: Diane Panasiuk, Tecumseh (CA)

(21) Appl. No.: 15/264,188

(22) Filed: Sep. 13, 2016

(30) Foreign Application Priority Data
Sep. 8, 2016 (CA) 2941311

(51) Int. Cl. A01D 34/82; A01D 34/73

(52) U.S. Cl. CPC A01D 34/82; A01D 2101/00; A01D 34/733

(57) ABSTRACT

A convexly curved metal blade is provided having a proximal end and a distal end, a convex face disposed between the proximal end and the distal end, and a sharpened cutting surface on the convex face of the blade, wherein the blade is pivotably connectable at the proximal end thereof to a rotatable cutterhead and wherein the convex curvature of the blade becomes more pronounced towards the distal end thereof. The blade can be manufactured proportionally; in size; operating principle; and quantity to adapt to any vertical axis rotational cutting device or mower.

### FIELD OF THE INVENTION

The invention relates to cutting blades for rotary cutters that mow vegetation by rotating cutting blades about a vertical axis.

### BACKGROUND

Rotary trimmers have been devised in the past with a rapidly rotating head that was held close to a surface with vegetation that needed trimming. In such a trimmer, flexible nylon line attached to the head is held disposed orthogonally outward from the head by the centrifugal force exerted by the rapidly rotating head, and as the head is rapidly rotated, the flexible nylon line is whipped around the head. As the whipping line is brought into contact with the vegetation, the whipping line slices the stalks of the vegetation, cutting off the tops of the vegetation. This type of rotary trimmer works satisfactorily so long as the vegetation stalks are fine and the vegetation is not too densely planted, such as the edge of a lawn. However, the flexible nylon line is relatively fragile and must be replaced fairly frequently as larger areas are trimmed, especially when obstacles such as thicker vegetation or fences are encountered.

More robust rotary vegetation trimmers were devised where rigid plastic blades were used instead of the flexible nylon line. In these trimmers, the rigid plastic blades are pivotably attached to the rotating heads. A commercial example of such a cutterhead is marketed by Stihl Limited of London, Ontario, Canada as STIHL PolyCut™ 20-3. A similar example may be seen in U.S. Pat. No. 5,852,876 to Wang. Such a cutterhead comprises a pair of spaced-apart, disc-shaped plates. A plurality of tubular posts project at right angles to the inner faces of the spaced-apart plates towards the outer circumferential edges of the plates, and a rigid plastic blade is mounted on each of these posts via a hole that goes through one end of the plastic blade. The hole is of a slightly larger diameter than the post so that the blade is free to pivot back and forth on the post that it is mounted on. However, as the cutterhead is rapidly rotated by the trimmer, the plurality of blades is held disposed orthogonally outward from the head by the centrifugal force exerted by the rapidly rotating head, so that the blades are whipped around the head, much the same way that a flexible nylon line is in the example discussed above.

The rapidly rotating rigid blades can cut vegetation in a similar manner to the rapidly rotating flexible line and may not wear out as quickly as the flexible line, but there are still several disadvantages to a cutterhead equipped with rigid, plastic blades.

A rigid, plastic blade will break the first time that it comes in contact with an immovable object or thick, heavy vegetation. If one or more of the plurality of blades attached to the cutter head breaks, the cutterhead will become out of balance and will have to be removed from service to change the broken blade or blades. It will take time to remove the cutterhead from the driveshaft of the trimmer, disassemble the cutterhead, replace the one or more broken blades, reassemble the cutterhead and reattach the cutterhead to the trimmer driveshaft. Downtime due to broken blades can be significant in a commercial operation. Alternatively, spare replacement cutterheads with rigid, plastic blades already installed may be kept at a jobsite, but costs must be incurred in acquiring and storing the spare cutterheads.

There is a need for blades that are more suited to cut thick vegetation in a rotary vegetation trimmer to stand in place of the rigid, plastic blades that are currently used yet still retain the ability to cut fine vegetation, such as blades of grass in a lawn. Advantageously, the blades can be manufactured proportionately, in size, operating principle, and quantity to adapt to, not only a mower or trimmer that cuts vegetation by rotating the blades about a vertical axis, but any vertical axis rotational cutting device.

### SUMMARY

According to one aspect of the present invention, there is provided a convexly curved metal blade having a proximal end and a distal end, a convex face disposed between the proximal end and the distal end, and a sharpened cutting surface on the convex face of the blade, wherein the blade is pivotably connectable at the proximal end thereof to a rotatable cutterhead and wherein the convex curvature of the blade becomes more pronounced towards the distal end thereof, wherein the blade can be manufactured proportionally; in size; operating principle; and quantity to adapt to any vertical axis rotational cutting device.

According to another aspect of the present invention, there is provided the convexly curved metal blade described herein, wherein the sharpened cutting surface on the convex face of the blade extends to the distal end of the convexly curved blade.

According to yet another aspect of the present invention, there is provided the convexly curved metal blade described herein, wherein the sharpened cutting surface on the convex face of the blade terminates towards the distal end of the convexly curved blade where the convex curvature of the blade becomes more pronounced and the convex face on the blade becomes a dull tip towards the distal end of the convexly curved blade where the convex curvature of the blade becomes more pronounced.

According to still another aspect of the present invention, there is provided the convexly curved metal blade described herein, wherein the sharpened cutting surface on the convex face of the blade is chevron-shaped or beveled in cross-sectional profile.

According to a further aspect of the present invention, there is provided the convexly curved metal blade described herein, wherein the vertical axis rotational cutting device is a mower.

According to yet a further aspect of the present invention, there is provided the convexly curved metal blade described herein, wherein the mower is a vegetation trimmer.

### BRIEF DESCRIPTION OF THE DRAWINGS

FIG. 1 is a bottom plan view of a cutterhead with three rigid, plastic blades mounted thereon (PRIOR ART).

FIG. 2 is a bottom plan view of a cutterhead with three convexly curved blades of an embodiment of the invention mounted thereon.

FIG. 3 is a bottom plan view of a convexly curved blade of the embodiment of the invention illustrated in FIG. 2.

FIG. 4 is a bottom plan view of the distal end of a convexly curved blade of the embodiment of the invention illustrated in FIG. 3.

FIG. 5 is a perspective view showing the details of the cutting edge towards the distal end of a convexly curved blade of an embodiment of the invention.

FIG. 6 is a perspective view showing the details of the cutting edge towards the distal end of a convexly curved blade of a different embodiment of the invention than that illustrated in FIG. 5.

### DETAILED DESCRIPTION

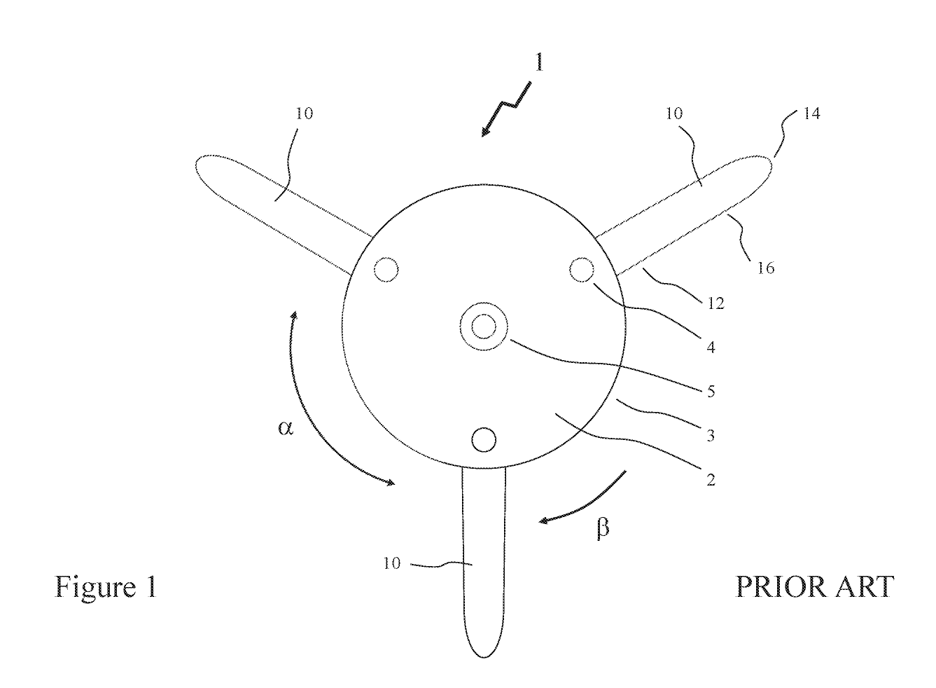

In the prior art cutterheads 1 with rigid, plastic blades, as described above and shown in FIG. 1, blades 10 are mounted between two spaced-apart, disc-shaped plates 2 of cutterhead 1. In the embodiment shown in FIG. 1, cutterhead 1 is shown from below, so only the lower plate 2 is visible. A second plate (not seen in FIG. 1) is held in a spaced-apart arrangement above the lower plate 2 in a fixed arrangement, wherein the two plates may be removed from each other.

In the prior art embodiment of FIG. 1, three rigid, plastic blades 10 are mounted on the cutterhead 1, wherein the blades 10 are spaced equidistant from one another towards the outer circumference 3 of the plates 2. Each blade 10 has a proximal end 12 and a distal end 14 and is mounted on a tubular pin 4 that extends between the two spaced-apart, disc-shaped plates 2 through a hole (not seen in FIG. 1) that extends through the thickness of the blade 10 towards the proximal end 12 of the blade 10. In the embodiment shown in FIG. 1, the outer face of pin 4 is visible through plate 2, but this is not necessarily so—pin 4 and the hole in blade 10 may both be totally obscured between space-apart, disc-shaped plates, 2. The diameter of the hole is larger than the diameter of the pin 4, so blade 10 is free to swing about pin 4 in either direction through angle α in the plane of the spaced-apart, disc-shaped plates 2.

In operation, cutterhead 1 is removably mounted on the drive shaft of a rotary vegetation trimmer (not shown) through mounting means 5 seen at the center of cutterhead 1. The motor of the rotary vegetation trimmer is able to rapidly rotate cutterhead 1 in the direction of arrow β such that each of blades 10 is held disposed orthogonally outward from the plates 2 by the centrifugal force exerted by the rapidly rotating cutterhead 1, so that the blades are whipped around the cutterhead 1 in the direction of arrow β, with face 16 becoming the leading face of the blade 10.

As rotating cutterhead 1 is moved towards vegetation, such as blades of grass growing in a lawn, each leading face 16 of blades 10 whipping about cutterhead 1 is brought in contact with the blades of grass to cut them.

Since the blades of grass are fine, whipping blades 10 are easily able to slice through the blades of grass. However, if vegetation is thicker such as tall grass or weeds with thicker stalks, the leading edge 16 of whipping blades 10 will deflect back towards the outer circumference 3 of plate 2 as cutterhead 1 continues to rotate in the direction of arrow β. It may be that whipping blades 10 lose their effectiveness in cutting thicker vegetation, or it may be that the rigid, plastic blades 10 eventually break or shatter as they are continually whipped against the stalks of thicker vegetation.

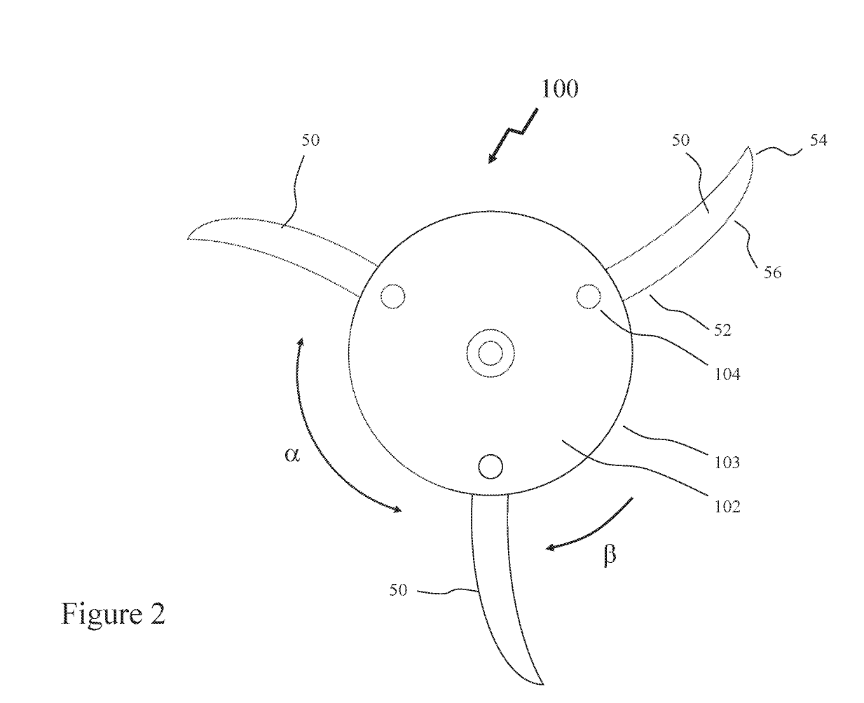

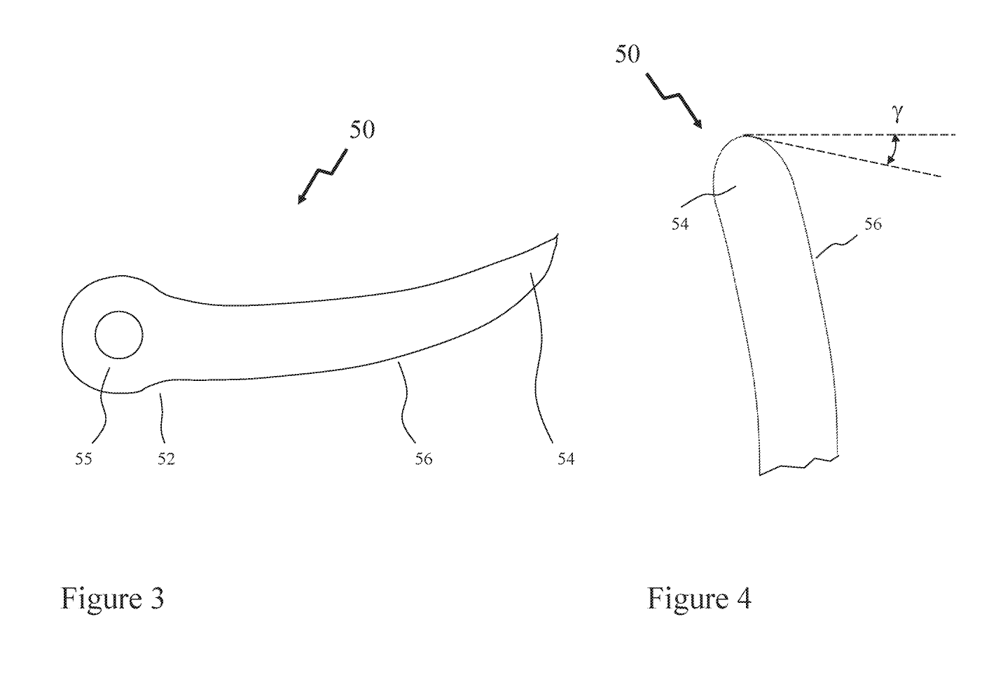

An individual blade 50 of the present invention is shown in FIG. 3 and three of the blades 50 of the present invention are shown mounted in a cutterhead 100 in FIG. 2 in a similar manner in which prior art blades 10 are mounted in cutterhead 1 in FIG. 1.

Blade 50 is shown in FIG. 3 as having a proximal end 52 and a distal end 54. Hole 55 is shown towards the proximal end 52.

Blades 50 mount on cutterhead 100, as shown in FIG. 2, in an analogous manner to the way blades 10 mount on cutterhead 1. Hole 55 at the proximal end 52 of blade 50 mounts over pin 104 that is positioned between spaced-apart, disc-shaped plates 102 towards the outer circumference thereof 103. Each blade is free to pivot about pin 104 through angle α in the plane of the plates 102; however, when cutterhead 100 is rapidly rotated in the direction of arrow β, each of blades 50 is held disposed orthogonally outward from the plates 102 by the centrifugal force exerted by the rapidly rotating cutterhead 100, so that the blades 50 are whipped around the cutterhead 100 in the direction of arrow β, with face 56 becoming the leading face of the blade 50.

Blade 50 is made of metal, such as steel and is convexly curved at leading face 56. Leading face 56 is sharpened over at least a part thereof to form a cutting surface. Additionally, the convex curve of leading face 56 becomes more pronounced (steeply convex) towards the distal end 54 of blade 50, as seen in FIG. 4. The angle of more pronounced curvature is seen as angle γ in FIG. 4 and ranges from 5 to 25 degrees.

As blade 50 is whipped around rapidly rotating cutterhead 100 and is pushed back about pivot 104 towards disc 102 as it strikes thick vegetation, blade 50 continues to move in the direction of arrow β. Because blade 50 has convex curvature on the leading face 56 thereof, and because the leading face 56 is sharpened over at least a portion thereof, there is a slicing motion across the vegetation that is more pronounced than in a blade that is not convexly curved. The applicant has observed that the cutting ability of the sharpened, metal convexly shaped leading edge 56 is tripled over the prior art rigid, plastic blade 10. Convexly curved blade 50 will continue rotating about cutterhead 100, even through thick vegetation, with blade 50 pushed back towards disc 102, producing a slicing force against the thick vegetation until the thick vegetation is sliced. As the convexly curved blade 50 is pushed back towards disc 102, the angle of contact with the leading edge 56 of the blade 50 will increase, diminishing the cutting circumference and increasing the horsepower available to cut. Even if the blades 50 are pushed back almost to the disc 102 by thick vegetation being cut, the blades 50 of cutterhead 100 will continue to cut effectively, without damaging the disc 102 of cutterhead 100.

The Applicant has observed that cutting with convexly curved blades 50 of the invention significantly decreases the amount of cut vegetation thrown by the blades 50 and the cut vegetation will not clog the cutterhead 100.

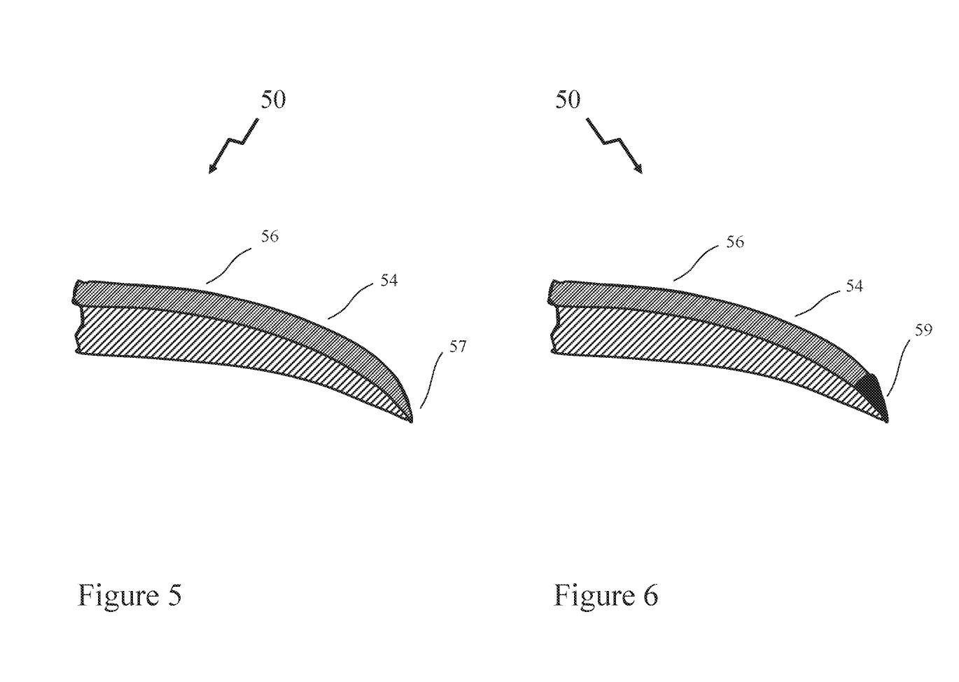

In one embodiment of the invention, sharpened cutting surface of leading face 56 continues along the leading face 56 until a sharpened tip 57 of the distal end 54 of the blade 50, through the region of more pronounced convex curvature. The feature of this embodiment will increase the cutting efficiency of blade 50, as slicing force of the blade will continue until blade disengages from the vegetation as it is whipped around cutterhead 100. As the convex curvature of blade 50 becomes more pronounced, the direction of the cutting force against the vegetation will alter slightly, thereby increasing the cutting efficiency of blade 50. The distal end 54 of a blade 50 displaying this embodiment is illustrated in FIG. 5.

In another embodiment of the invention, sharpened cutting surface of leading face 56 terminates at the distal end 54 just before the region of more pronounced curvature, as shown in FIG. 6, thereby forming a non-sharpened bumper tip 59 at the region of more pronounced convex curvature. The bumper 59 keeps the tip of the leading edge 56 of blade 50 from cutting when the cutterhead 100 is operating at low revolutions per minute (RPMs) during trimming, allowing the cutterhead 100 to bounce off obstacles such as fences in operation. Using blades 50 with bumpers 59 at the distal end 54 allows a trimmer operator to “feel” the object being trimmed as the rotating cutterhead 100 approaches it without causing damage. This feature prevents damage to the blade 50 and promotes longer blade life.

In one embodiment of the invention, the cutting surface of leading face 56 of the convexly curved blade 50 tapers to a point from both the top and bottom such that the cutting surface at the leading face 56 forms a chevron-shape, when seen in cross-section across the blade 50. This chevron cutting shape provides for good cutting. Any nicks that develop in the blade 50 will not throw the blade out of balance and can be filed out at the end of operation of the trimmer by the operator. Furthermore, the convex face of the blade can be beveled from bottom to top in cross-sectional profile.

In operation, rapidly rotating blades 50 on cutterhead 100 may be brought down over vegetation from above, even when the vegetation is thick, to cut through the vegetation in a stepwise fashion, thereby creating a fine mulch. Alternatively, rapidly rotating blades on cutterhead 100 may be brought towards the vegetation from the side to cut through the vegetation in one step, towards the base of the vegetation in a situation where the operator of the trimmer would prefer to remove large pieces of cut vegetation.

If the blades 50 of cutterhead 100 strike an immoveable object, the blades 50 might nick at the leading edge 56, but will not break. The nick will not render the cutterhead 100 inoperable or place the cutterhead 100 out of balance. The nick may be repaired by the operator of the trimmer at the end of operation of the trimmer with a file.

Blades 50 may have a visible code, such as a color code, applied to either the top or bottom surface thereof to more easily ensure that blades are all installed in a cutterhead 100 uniformly, with the convex leading edge 56 facing forward in the direction that the cutterhead 100 will be rotating in.

Blades 50 of the invention can be manufactured in various sizes to fit in various different cutterheads and can be installed in various quantities to match available mounting pin positions on the various different cutterheads. As such, blades 50 of the invention can be adapted to be mounted on any vertical axis rotational cutting device or mower. The person skilled in the art would be able to construct a blade 50 of the invention in the right proportions to be used in a given situation based upon the operating principles of the blade 50 of the invention discussed herein.

An individual cutterhead 100 may be mounted on a hand held trimmer for manual use, or plurality of cutterheads 100 may be mounted to be driven on a larger piece of turf maintenance equipment.

Trials by the Applicant have shown that a rotary vegetation trimmer using a cutterhead 100 equipped with the blades 50 of the present invention will have five times the performance of one using a cutterhead 1 equipped with rigid, plastic blades 10 of the prior art, with less operator fatigue and no down-time due to failure of the rigid, plastic blades 10 of the prior art. The Applicant would expect the convexly curved metal blades 50 of the invention to last the lifetime of a trimmer in household use and to last a season when used by a commercial landscaping operator.

The Applicant has observed that a rotary vegetation trimmer using a cutterhead 100 equipped with the convexly curved metal blades 50 of the present invention will have many advantages of one using a cutterhead 1 equipped with rigid, plastic blades 10 of the prior art or a cutterhead equipped with fine nylon filament (a string trimmer) of the prior art due to the design of convexly curved metal blades 50 of the present invention. Plastic blades and strings need to operate at high revolutions per minute (RPM) to cut effectively. However, due to the high RPM, plastic blades and strings throw excessive debris in all directions. In contrast, the convexly curved metal blades 50 of the present invention can outperform plastic blades or stings at extremely low RPM and consequently throw very little debris, improving safety to the operator and by-standers. Plastic blades and strings pollute the environment when pieces of broken plastic and string are left behind after vegetation is trimmed, whereas the convexly curved metal blades 50 of the present invention leave no such broken pieces, which is more environmentally friendly. Plastic blades and string are expensive over the life of the trimmer as they need to be constantly replaced. The convexly curved metal blades 50 of the present invention are far more long-lasting and therefore far less expensive over the life of the trimmer. Plastic blades and strings may only be used in a trimmer to cut small vegetation. A trimmer equipped with the convexly curved metal blades 50 of the present invention may be used to trim large or small vegetation. A trimmer with plastic blades or strings will get plugged up in tall vegetation, whereas one with the convexly curved metal blades 50 of the present invention cuts with a slicing action that is self-clearing and self-adjusting for better performance. Plastic blades and strings constantly break and consequently need to be re-loaded in the trimmer by the operator, causing excessive downtime. The convexly curved metal blades 50 of the present invention do not break, which eliminates a source of downtime and leads to a significant increase in productivity.

1. A convexly curved metal blade having a proximal end and a distal end, a convex face disposed between the proximal end and the distal end, and a sharpened cutting surface on the convex face of the blade, wherein the blade is pivotably connectable at the proximal end thereof to a rotatable cutterhead and wherein the convex curvature of the blade becomes more pronounced towards the distal end thereof, wherein the blade can be manufactured proportionally; in size; operating principle; and quantity to adapt to any vertical axis rotational cutting device.

2. The convexly curved metal blade of claim 1, wherein the sharpened cutting surface on the convex face of the blade extends to the distal end of the convexly curved blade.

3. The convexly curved metal blade of claim 1, wherein the sharpened cutting surface on the convex face of the blade terminates towards the distal end of the convexly curved blade where the convex curvature of the blade becomes more pronounced and the convex face on the blade becomes a dull tip towards the distal end of the convexly curved blade where the convex curvature of the blade becomes more pronounced.

4. The convexly curved metal blade of claim 1, wherein the sharpened cutting surface on the convex face of the blade is chevron-shaped in cross-sectional profile.

5. The convexly curved metal blade of claim 1, wherein the sharpened cutting surface on the convex face of the blade is beveled from bottom to top in cross-sectional profile.

6. The convexly curved metal blade of claim 1, wherein the vertical axis rotational cutting device is a mower.

7. The convexly curved metal blade of claim 6, wherein the mower is a vegetation trimmer.
